(19) United States
(12) Patent Application Publication
(10) Pub. No.: US 2016/0136994 A1
(43) Pub. Date: May 19, 2016

(54) SYSTEM AND METHOD FOR MARKING ARTIFICIAL TURF MATS AND ARTIFICIAL TURF MATS

(71) Applicant: Juan Miguel MAYORDOMO VICENTE, Barcelona (ES)

(72) Inventor: Juan Miguel MAYORDOMO VICENTE, Barcelona (ES)

(21) Appl. No.: 14/895,496

(22) PCT Filed: Jun. 5, 2014
(86) PCT No.: PCT/ES2014/070467

§ 371 Date: Dec. 3, 2015

(30) Foreign Application Priority Data
Jun. 5, 2013 (ES) P201330834

(51) Int. Cl. B44C 1/24; B44C 1/22; B41J 3/407; A63C 19/04

(52) U.S. Cl. CPC B44C 1/24; A63C 19/04; B44C 1/228; B44C 1/225; B44C 1/221; B41J 3/407

(57) ABSTRACT

A system for marking artificial turf mats that allows for the obtaining of artificial turf mats with indelible motifs on any of the surfaces of said mats, comprising positioning means for at least one mat and printing means applicable onto at least one surface of said mat, so that said printing means are capable of producing at least one motif onto the surface of said mat.

### PURPOSE OF THE INVENTION

The object of the present application for a patent of invention is to register a system and method for marking artificial turf mats incorporating significant innovations.

More specifically, the invention proposes the development of a marking system and method for artificial turf mats that allows for the obtaining of artificial turf mats with indelible markings on some of the surfaces of said mats.

### BACKGROUND OF THE INVENTION

Suitable methods and systems for the inclusion of markings and motifs on natural turf are well-known, such as for example the application of pigments onto the turf after a series of templates or the like. Another known method consists of the adoption of machinery or tools to mow the turf in different directions or angles to provide a differentiating aspect within the mowed area. the use of canvasses or the like placed on the surface of the turf, is also contemplated, but this involves the manufacture and labelling of canvasses that will be used only once, that can be moved from their initial location and even lead to accidents caused to users stepping on these.

With regard to artificial turf, as there is no need to mow it, methods such as the application of pigments should be used. However, over time, the weather conditions and wear and tear mean that the pigments gradually fade and detach from the artificial turf's fibres. There are other known methods for marking artificial turf such as the incorporation of canvasses or bands and strips that involve the same disadvantages as the natural turf. It is also possible to use fibres of artificial turf of different tones during the manufacture of surfaces such as mats or the like; nonetheless, this method increases the complexity of manufacture.

### DESCRIPTION OF THE INVENTION

The present invention has been developed with the aim of providing a system and method for marking artificial turf that solves the previously mentioned issues, providing, furthermore, other additional advantages that will be evident from the following description.

It is therefore an aim of this invention, to provide a system and method for marking artificial turf, comprising positioning means for at least one mat and printing means applicable to at least one surface of said mat, in such a way that said printing means are capable of producing at least one motif on the surface of said mat.

Thanks to these characteristics a marking system is obtained that allows for the printing of motifs onto a surface such as a mat in a simple and indelible manner. The user who moves over or carries out any activity on said surface of artificial turf can note and remark the motifs, signals or indelible markings, permanently marked so it is not necessary to repeat the markings. The use of the present system will be possible irrespective of the sizing of the mat to be marked. Furthermore, safety is increased for users who move over the marked areas, reducing considerably the risk of slipping or falling in comparison with the traditional systems, which include the application of pigments or the addition of objects such as canvasses, banners or even three-dimensional objects that emerge from the surface of the turf.

It should be pointed out that in this description and claims the term “mat” shall be construed as referring to any artificial turf surface irrespective of its dimensions.

Said printing means may vary depending on the embodiments, such as presenting a laser beam transmitter, a milling head linked to drive means that might in turn comprise an electrical engine, a mechanism capable of producing a jet of abrasive liquid, a mechanism capable of producing a jet of abrasive sand or even come fitted with a cliché that can be heated, said cliché being movable with respect to the mat in such a way that said cliché can press at least one surface of said mat.

The printing means can be linked to a template to follow a marking pattern on the mat. On the other hand, said positioning means can have a base capable of holding said mat, with the aforementioned base being fitted with at least one fixing element.

Another aim of this invention is a method for marking artificial turf mats, comprising the stages of positioning an artificial turf mat and then applying printing means onto said mat. Additionally, the method may include the possibility of placing a template onto said mat, prior to the application of the printing means.

An additional aim of this invention is an artificial turf mat marked using the method for marking artificial turf mats mentioned and described above.

Other characteristics and advantages of the system for marking artificial turf mats object of the present invention will become evident from the description of a non-exclusive but nonetheless preferred embodiment, which is illustrated by way of a non-limitative example in the attached drawings, in which:

### BRIEF DESCRIPTION OF THE DRAWINGS

FIG. 1—is a schematic perspective view of a first embodiment of the system for marking artificial turf mats object of the invention;

FIG. 2—is a schematic perspective view of a second embodiment of the system for marking artificial turf mats object of the invention;

FIG. 3—is a schematic perspective view of a third embodiment of the system for marking artificial turf mats object of the invention; and,

FIG. 4—is a schematic perspective view of a fourth embodiment of the system for marking artificial turf mats object of the invention.

### DESCRIPTION OF PREFERRED EMBODIMENT

In view of the aforementioned figures, and in accordance with the numeration adopted, an example of preferred embodiment of the invention can be observed, which comprises the parts and elements that are indicated and described in detail in the forthcoming section.

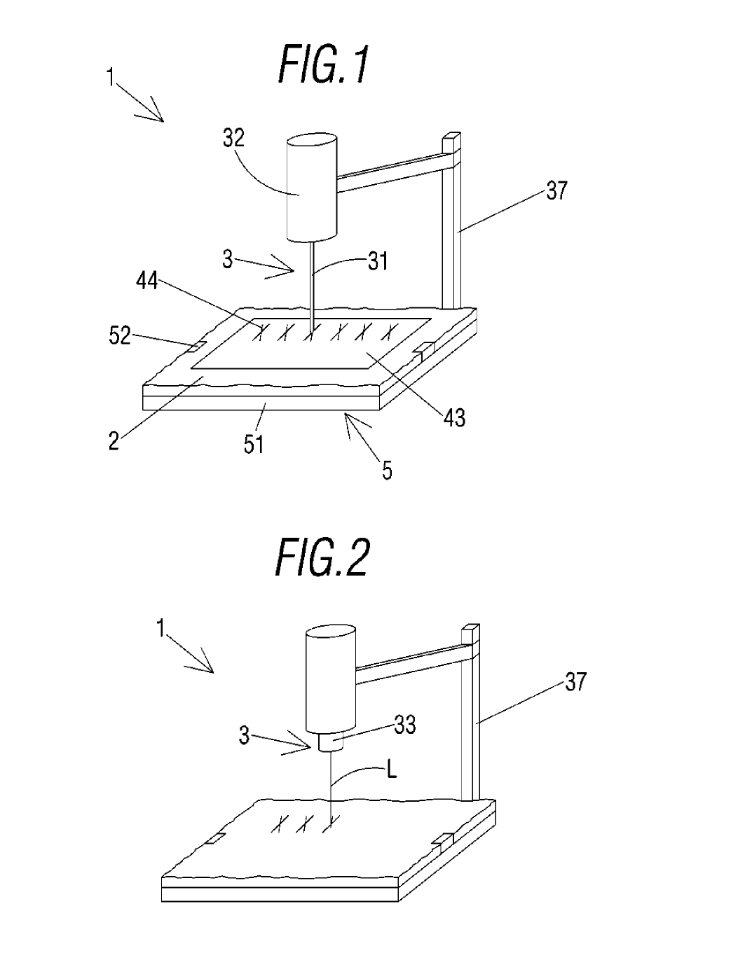

In FIG. 1 a first embodiment of the present invention is shown regarding a system for marking artificial turf mats, generally denoted with the numerical reference 1. this system for marking artificial turf mats 1 comprises positioning means 5 for said mat 2 and printing means 3 applicable on, for example, a surface of said mat 2. Said printing means 3 can be used to produce a motif 44 or a series of motifs 44 on the surface of said mat 2.

Preferentially, said positioning means 5 have a base 51 that can hold said mat 2, with the aforesaid base 51 being fitted with a pair of fixing elements 52. Although in the present embodiments two fixing elements 52 have been envisaged, it is obvious that a different number may be employed depending on the particular needs of each case. As an alternative, the positioning means 5 could represent any configuration allowing the user to relate correctly the printing means 3 relative to the mat 2.

Preferentially, the printing means 3 have a milling head 31 linked to drive means that may comprise, for example, an electrical engine 32. The milling head 31 and electrical engine 32 are fastened held in place using an arm 37 or the like, although it will be obvious for a person skilled in the art that said arm 37 could be replaced with a column, for example, or any other element that fulfils a similar function.

In this FIG. 1, a template 43 that can be linked to said printing means 3, is also illustrated. This template 43 can act as a guideline for the user in the marking of the mat 2 with the printing means 3; nonetheless, guided and controlled printing means 3 may be used by means of the automated arm 37, for example guided by an electronic system of numerical control available in the state of the art.

Continuing on to FIG. 2, a second embodiment can be seen in which the printing means 3 have a laser beam transmitter 33. As in FIG. 1, an automated arm 37, which can hold the laser beam transmitter 33, has also been represented here. A person skilled in the art may select such transmitter 33 amongst any of those available on the market that may be suitable for said purpose, in other words, capable of creating an indelible motif 44 onto a surface of the mat 2. The representation of a laser beam I de can be seen from the transmitter 33.

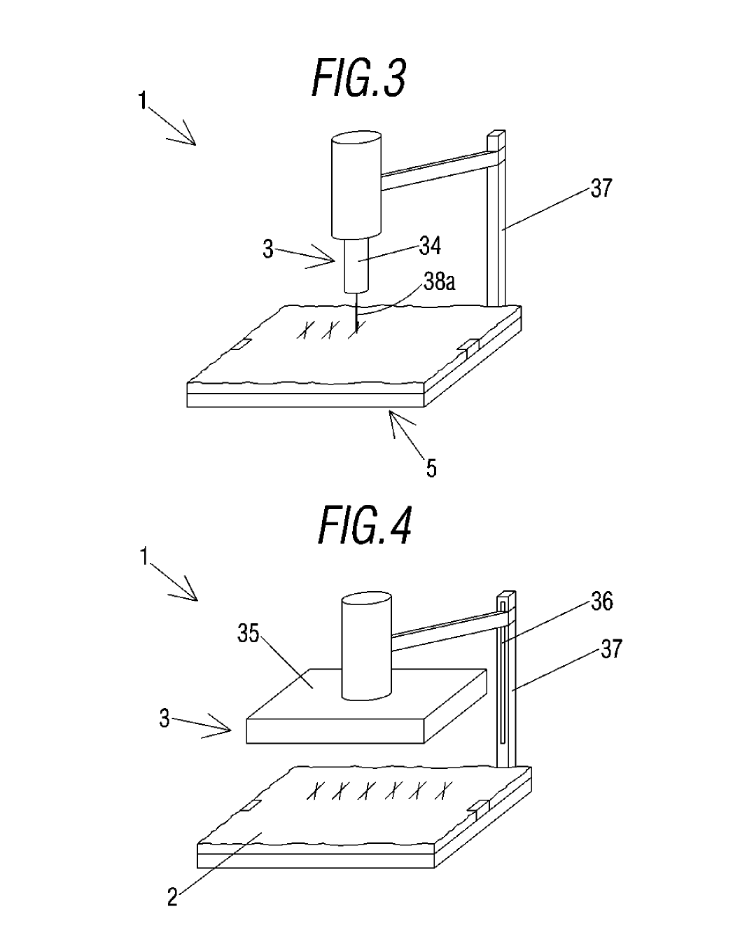

In FIG. 3, a third embodiment of the invention can be appreciated; the printing means 3 have a mechanism 34 capable of producing an abrasive jet 38, said abrasive jet 38 being either liquid or sand. The mechanism 34 may be any of those available on the market that can fulfil said function and for this reason, we shall not enter into more details with regard to this mechanism 34.

In FIG. 4, a fourth embodiment of the invention is represented, in which the printing means 3 have a cliché 35 that can be heated, said cliché 35 being able to move with respect to the mat 2 in such a way that said cliché 35 is capable of pressing at least one surface of said mat 2. To allow for the relative movement of the cliché 35 with respect to the mat 2, a guide 36 has been provided, along which the cliché assembly 35 moves. Said guide 36 is attached to the arm 37. As an alternative, an arm 37 can be installed, which is capable of moving the cliché 35 without the need for a guide 36. With regard to the heating of the cliché 35 known methods such as resistors and the like, installed in the interior of the cliché 35, for example, may be used. Said cliché 35 could be made of any material suitable for this purpose.

Whenever the user wishes to mark an artificial turf mat 2, this will be preferably positioned on the base 51 and advantageously may be held in place with the fixing elements 52. Following this, the user may program the printing means 3 or use a template 43 or the like with a pattern to be followed; as an alternative, said printing means 3 are not programmable. In the example of the first embodiment shown in FIG. 1, the milling head 31 will be in contact with the surface of the mat 2 and will commence the abrasive action to mark the motifs 44 in an indelible manner as required by the user. With the rest of the alternatives described in the present embodiments, the user will also obtain a mat 2 similar to those used preferably when playing golf. In this way, the user of the mat 2 used on golf courses will have within reach in a quick, reliable and safe manner, a series of motifs 44, in the form of signs that can provide indications for playing golf, such as for example, directions, intensity, or preferred club to be used; nonetheless, other type of useful indications for the user should not be overlooked.

The details, shapes, dimensions and other accessory elements, as well as the materials used in the manufacture of the system and method for marking artificial turf mats 1 of the invention may be conveniently replaced with others that are technically their equivalent and which do not depart from the essential nature of the invention or the scope defined by the claims that are included below.

1. A system for marking artificial turf mats (1), characterised by the fact that it comprises positioning means (5) for at least one mat (2) and printing means (3) applicable onto at least one surface of said mat (2), such that said printing means (3) are capable of producing at least one motif (44) onto the surface of said mat (2).

2. The system for marking artificial turf mats (1) according to claim 1, characterised by the fact that said printing means (3) have a laser beam transmitter (33).

3. The system for marking artificial turf mats (1) according to claim 1, characterised in the fact that said printing means (3) have a milling head (31) linked to drive means.

4. The system for marking artificial turf mats (1) according to claim 3, characterised by the fact that said drive means comprise an electrical engine (32).

5. The system for marking artificial turf mats (1) according to claim 1, characterised by the fact that said printing means (3) have a mechanism (34) capable of producing an abrasive liquid jet (38).

6. The system for marking artificial turf mats (1) according to claim 1, characterised by the fact that said printing means (3) have a mechanism (34) capable of producing an abrasive sand jet (38).

7. The system for marking artificial turf mats (1) according to claim 1, characterised by the fact that said printing means (3) have a cliché (35) that can be heated, said cliché (35) being moveable with respect to the mat (2) in such a way that said cliché (35) is capable of pressing at least one surface of said mat (2).

8. The system for marking artificial turf mats (1) according to claim 1, characterised by the fact that it further comprises a template (43) that can be linked to said printing means (3).

9. The system for marking artificial turf mats (1) according to claim 1, characterised by the fact that said positioning means (5) have a base (51) that can hold said mat (2), said base (51) being fitted with at least one fixing element (52).

10. A method for marking artificial turf mats, characterised by the fact that it comprises the stages of positioning a mat (2) made from artificial turf and then applying printing means (3) onto said mat (2).

11. The method for marking artificial turf mats according to claim 10, characterised by the fact that a template (43) is placed onto said mat (2).

12. A mat (2) made from artificial turf marked using the method for marking artificial turf mats according to claim 10.
